(19) United States
(12) Patent Application Publication
(10) Pub. No.: US 2023/0252552 A1
(43) Pub. Date: Aug. 10, 2023

(54) E-GIFTING SYSTEM AND METHOD

(71) Applicant: ASUSTEK COMPUTER INC., TAIPEI (TW)

(72) Inventors: Kuo-Chung CHIU, TAIPEI (TW); Hsuan-Wu WEI, TAIPEI (TW); Yi-Hua HUANG, TAIPEI (TW); Chun-Hao LIAO, TAIPEI (TW)

(21) Appl. No.: 17/939,646

(22) Filed: Sep. 7, 2022

(30) Foreign Application Priority Data
Feb. 9, 2022 (TW) 111104666

(51) Int. Cl. G06Q 30/06; G06Q 10/08; G06Q 50/00; G06Q 20/10

(52) U.S. Cl. CPC G06Q 30/0633; G06Q 10/087; G06Q 50/01; G06Q 20/10

(57) ABSTRACT

An e-gifting method is provided. The method is performed by a computer device including a processing unit, and includes: receiving, by the processing unit, gift filtering information and receiver information from a giver terminal device; generating, by the processing unit, a candidate gift list according to the gift filtering information and the receiver information, where the candidate gift list includes a plurality of candidate gift items; generating, by the processing unit, a gifting list from the candidate gift items according to giver selecting information from the giver terminal device, where the gifting list includes a plurality of gifting gift items; confirming, by the processing unit, a selected gift item from the gifting gift items according to receiver selecting information from a receiver terminal device; and transmitting, by the processing unit, payment information corresponding to the selected gift item to the giver terminal device.

### CROSS-REFERENCE TO RELATED APPLICATION

This application claims the priority benefit of Taiwan application serial No. 111104666, filed on Feb. 9, 2022. The entirety of the above-mentioned patent application is hereby incorporated by reference herein and made a part of the specification.

### BACKGROUND OF THE INVENTION

### Field of the Invention

The disclosure relates to an e-gifting system and method.

### Description of the Related Art

In daily life and work, relatives, friends and clients often express courtesy and affection by giving and receiving gifts. However, when selecting a gift, a giver often needs to spend time thinking about a suitable gift, and the selected gift often does not meet the need of a receiver, and even causes a burden on the receiver.

Although the existing e-gifting platform simplifies a procedure of selecting a gift for gifting, a problem that the gift selected by the giver does not meet the need of the receiver is still not resolved.

### BRIEF SUMMARY OF THE INVENTION

The disclosure provides an e-gifting method. The e-gifting method is performed by a computer device. The computer device includes a processing unit. The e-gifting method includes the following steps: receiving, by the processing unit, gift filtering information and receiver information from a giver terminal device; generating, by the processing unit, a candidate gift list according to the gift filtering information and the receiver information, where the candidate gift list includes a plurality of candidate gift items; generating, by the processing unit, a gifting list from the candidate gift items according to giver selecting information from the giver terminal device, where the gifting list includes a plurality of gifting gift items; confirming, by the processing unit, a selected gift item from the gifting gift items according to receiver selecting information from a receiver terminal device; transmitting, by the processing unit, payment information corresponding to the selected gift item to the giver terminal device; and receiving, by the processing unit, a reply message corresponding to the selected gift item from the receiver terminal device, and transmitting the reply message to the giver terminal device.

The disclosure further provides an e-gifting system. The e-gifting system includes a computer device and a storage server. The computer device includes a processing unit, configured to: receive gift filtering information and receiver information from a giver terminal device; generate a candidate gift list according to the gift filtering information and the receiver information, where the candidate gift list includes a plurality of candidate gift items; generate a gifting list from the candidate gift items according to giver selecting information from the giver terminal device, where the gifting list includes a plurality of gifting gift items; confirm a selected gift item from the gifting gift items according to receiver selecting information from a receiver terminal device; transmit payment information corresponding to the selected gift item to the giver terminal device; and receive a reply message corresponding to the selected gift item from the receiver terminal device, and transmit the reply message to the giver terminal device. The storage server stores inventory information. The processing unit generates the candidate gift list according to the gift filtering information, the receiver information and the inventory information.

In the e-gifting system and method provided in the disclosure, gift filtering information provided by a giver and receiver information are used to generate a candidate gift list, so as to reduce the trouble for the giver when selecting a gift. In addition, because a receiver selects a desired gift item in a gifting list, the e-gifting system and method provided in the disclosure also help improve the satisfaction of the receiver.

### BRIEF DESCRIPTION OF THE DRAWINGS

FIG. 1 is a schematic block diagram of an embodiment of an e-gifting system according to the disclosure;

FIG. 2 shows an embodiment of operations of the e-gifting system in FIG. 1;

FIG. 3 is a flowchart of an embodiment of an e-gifting method according to the disclosure; and

FIG. 4 is a schematic block diagram of another embodiment of an e-gifting system according to the disclosure.

### DETAILED DESCRIPTION OF THE EMBODIMENTS

More detailed descriptions of the specific embodiments of the disclosure are provided below with reference to the accompanying drawings. The features and advantages of the disclosure are described more clearly according to the following description and claims. It should be noted that all of the drawings use very simplified forms and imprecise proportions, only being used for assisting in conveniently and clearly explaining the objective of the embodiments of the disclosure.

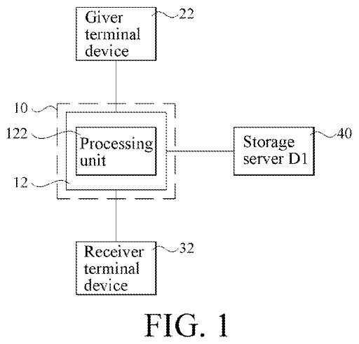

FIG. 1 is a schematic block diagram of an embodiment of an e-gifting system according to the disclosure. As shown in the figure, the e-gifting system includes an e-gifting platform 10 for sending a gift to a receiver by a giver.

The e-gifting platform 10 cooperates with a giver terminal device 22 and a receiver terminal device 32. The giver terminal device 22 and the receiver terminal device 32 are desktop computers, notebook computers, tablet computers, mobile phones or other electronic devices including a man-machine interface for communicating with a user. The giver terminal device 22 and the receiver terminal device 32 are both connected to the e-gifting platform 10. The giver terminal device 22 and the receiver terminal device 32 communicate with the e-gifting platform 10 in a wired manner or a wireless manner.

The e-gifting platform 10 includes a computer device 12. The computer device 12 includes a processing unit 122. The computer device 12 is an electronic device with a calculation function and a connection function, such as a server, a desktop computer, or a notebook computer.

In addition to being connected to the giver terminal device 22 and the receiver terminal device 32, the computer device 12 is also connected to a storage server 40 of a warehouse, to obtain inventory information D1 of the warehouse. The inventory information D1 corresponds to an actual storage status of the warehouse, and is updated in real time according to the actual storage status of the warehouse.

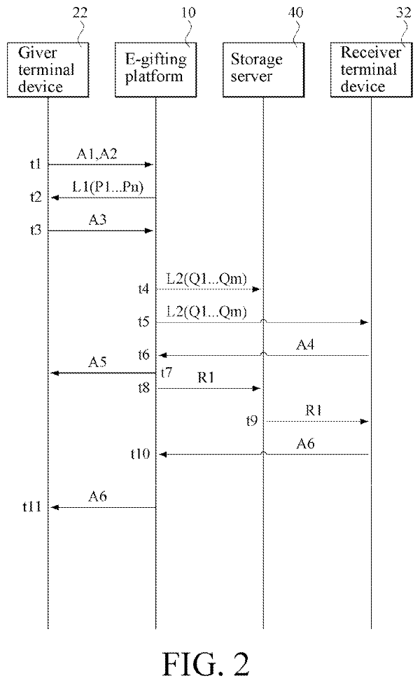

Referring to FIG. 1 and FIG. 2 together, FIG. 2 shows an embodiment of operations of the e-gifting system in FIG. 1. A chronological order of the operations in the figure is from top to bottom.

First, as shown by an arrow t1, after the giver decides to give a gift to the receiver, the e-gifting platform 10 receives receiver information A1 and gift filtering information A2 from the giver terminal device 22.

Then, as shown by an arrow t2, after receiving the gift filtering information A2 and the receiver information A1 from the giver terminal device 22, the e-gifting platform 10 generates a candidate gift list L1 and transmits the candidate gift list L1 to the giver terminal device 22 for the giver to select. The candidate gift list L1 includes a plurality of candidate gift items P1 . . . Pn. In an embodiment, referring to FIG. 1 together, the foregoing operations is performed by the processing unit 122.

In an embodiment, the processing unit 122 is a central processing unit or a functional unit in a central processing unit. In an embodiment, the e-gifting platform 10 generates the candidate gift list L1 after confirming inventory products according to the inventory information D1 from the storage server 40.

In an embodiment, the receiver information A1 is at least one selected from a group including age, gender, and preference. In an embodiment, the receiver information A1 includes social networking site information. In an embodiment, the gift filtering information A2 is an amount range. A difference between the gift filtering information A2 and the receiver information A1 is that the gift filtering information A2 is set by the giver and does not involve a condition of the personal characteristics of the receiver. In contrast, the receiver information A1 is information involving the personality of the receiver.

In an embodiment, after receiving the receiver information A1 and the gift filtering information A2, the e-gifting platform 10 filters out inappropriate products by using the gift filtering information A2, such as overly expensive products; and also analyzes the receiver information A1 to obtain detailed information such as age, gender, and preference, and gives different calculation weights such as age 30%, gender 20%, and preference 15% to the detailed information. Second, the e-gifting platform 10 alternatively gives a calculation weight such as 15% according to the inventory information D1. The e-gifting platform 10 alternatively gives a calculation weight such as 15% based on popularity.

The e-gifting platform 10 obtains scores of product items in terms of detailed information, inventory, and popularity according to the foregoing detailed information, inventory, and popularity. In an embodiment, if the receiver information A1 shows that the receiver is a woman, male products are rated a low score in terms of gender; and if the receiver information shows that the receiver is a teenager, silver-haired products are rated a low score in terms of age. In addition, the inventory information D1 shows that a product with low inventory is rated a low score in terms of inventory. A current popular product is rated a high score in terms of popularity. After adding up the products obtained by multiplying these scores by the calculation weights, the obtained value is used to generate the candidate gift list L1.

Next, as shown by an arrow t3, the giver selects a proper gift item in the candidate gift list L1 through the giver terminal device 22 to generate giver selecting information A3 and transmit the giver selecting information A3 to the e-gifting platform 10.

After receiving the giver selecting information A3 from the giver terminal device 22, the e-gifting platform 10 generates a gifting list L2 from the candidate gift items P1 . . . Pn. The gifting list L2 includes a plurality of gifting gift items Q1 . . . Qm. These gifting gift items Q1 . . . Qm are selected from the candidate gift items P1 . . . Pn, that is, m is an integer less than n. In an embodiment, referring to FIG. 1 together, the foregoing operations is performed by the processing unit 122.

In an embodiment, when the giver terminal device 22 transmits the giver selecting information A3, the e-gifting platform 10 also requests the giver to provide corresponding payment information or deposit through the giver terminal device 22.

After the e-gifting platform 10 generates the gifting list L2, as shown by an arrow t4, the e-gifting platform 10 instructs the storage server 40 to lock or hide the gifting gift items Q1 . . . Qm in the gifting list L2 in the inventory information D1, so as to prevent these gifts from being taken away by others. In addition, as shown by an arrow t5, the e-gifting platform 10 transmits the gifting list L2 to the receiver terminal device 32 for the receiver to select.

In an embodiment, the quantity of the gifting gift items Q1 . . . Qm in the gifting list L2 is three. In other embodiments, an upper limit is alternatively set for the quantity of the gifting gift items Q1 . . . Qm in the gifting list L2.

Then, as shown by an arrow t6, the receiver selects a desired gift in the gifting list L2 through the receiver terminal device 32 to generate receiver selecting information A4 and transmit the receiver selecting information A4 to the e-gifting platform 10. After receiving the receiver selecting information A4 from the receiver terminal device 32, the e-gifting platform 10 confirms a selected gift item R1 from the gifting gift items Q1 . . . Qm. The selected gift item R1 is a gift selected by the receiver in the gifting list L2. In an embodiment, referring to FIG. 1 together, the foregoing operations is performed by the processing unit 122.

The receiver selecting information A4 in this embodiment corresponds to a single gift, that is, the receiver selects only one gift in the gifting list L2. However, the disclosure is not limited thereto. In other embodiments, the quantity of gifts corresponding to the receiver selecting information A4 is not limited. In other embodiments, the quantity of gifts corresponding to the receiver selecting information A4 is alternatively set by the giver through the giver terminal device 22.

Next, as shown by an arrow t7, after confirming the selected gift item R1, the e-gifting platform 10 immediately transmits payment information A5 corresponding to the selected gift item to the giver terminal device 22.

On the other hand, as shown by an arrow t8 and an arrow t9, the e-gifting platform 10 also instructs the storage server 40 to perform a gift delivery procedure, and unlocks or reveals other gift items Q1 . . . Qm in the inventory information D1 other than the selected gift item R1.

The foregoing gift delivery procedure is described by using an example. If the gift selected by the receiver is a physical gift, the e-gifting platform 10 instructs the storage server 40 of the warehouse to send a physical gift corresponding to the selected gift item to the receiver. If the gift selected by the receiver is a digital gift, the e-gifting platform 10 instructs a gift server to send a digital gift corresponding to the selected gift item or a download link thereof to the receiver terminal device 32.

Then, as shown by an arrow t10 and an arrow t11, after confirming that the receiver receives the gift, the e-gifting platform 10 queries the receiver whether there is a reply corresponding to the selected gift item through the receiver terminal device 32. If there is a reply message A6 from the receiver terminal device 32, the e-gifting platform 10 receives the reply message A6 and transmits the reply message A6 to the giver terminal device 22. In an embodiment, referring to FIG. 1 together, the foregoing operations is performed by the processing unit 122. In an embodiment, the reply message A6 includes an electronic thank-you card provided by the e-gifting platform 10.

In an embodiment, the e-gifting platform 10 has a built-in machine learning module. The machine learning module collects information from each successful gifting for learning, so that the candidate gift list L1 is more in line with the preferences of the giver and the receiver.

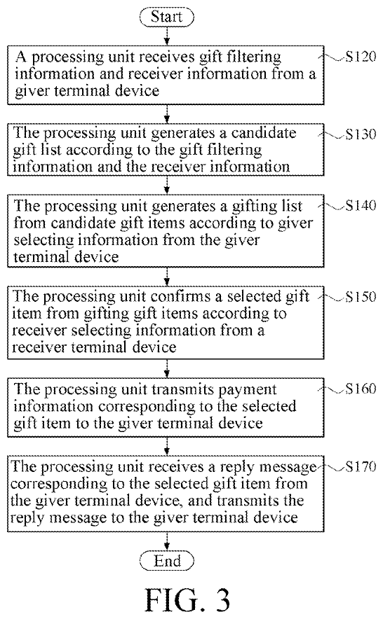

FIG. 3 is a flowchart of an embodiment of an e-gifting method according to the disclosure. The e-gifting method is implemented by the e-gifting platform 10 in FIG. 1. The e-gifting method includes the following steps.

First, as described in step S120, the processing unit 122 receives gift filtering information A2 and receiver information A1 from the giver terminal device 22.

Then, as described in step S130, the processing unit 122 generates a candidate gift list L1 according to the gift filtering information A2 and the receiver information A1. The candidate gift list L1 includes a plurality of candidate gift items P1 . . . Pn.

Then, as described in step S140, the processing unit 122 generates a gifting list L2 from the candidate gift items P1 . . . Pn according to giver selecting information A3 from the giver terminal device 22. The gifting list L2 includes a plurality of gifting gift items Q1 . . . Qm.

Next, as described in step S150, the processing unit 122 confirms a selected gift item R1 from the gifting gift items Q1 . . . Qm according to receiver selecting information A4 from the receiver terminal device 32.

Then, as described in step S160, the processing unit 122 transmits payment information A5 corresponding to the selected gift item R1 to the giver terminal device 22.

Next, as described in step S170, the processing unit 122 receives a reply message A6 corresponding to the selected gift item R1 from the receiver terminal device 32, and transmits the reply message A6 to the giver terminal device 22.

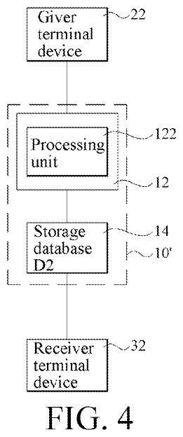

FIG. 4 is a schematic block diagram of another embodiment of an e-gifting system according to the disclosure. Compared with the embodiment in FIG. 1, in addition to the computer device 12 for processing information from the receiver terminal device 32 and the giver terminal device 22, the e-gifting platform 10′ of this embodiment further includes a storage database 14. Inventory information D2 in the storage database 14 corresponds to a storage status of a warehouse, and is updated in real time according to an actual storage status.

Compared with the embodiment in FIG. 1, the e-gifting platform 10′ of this embodiment directly confirms inventory of gifts from the storage database 14, and does not need to be connected to an external storage server 40. Other features of the e-gifting platform 10′ and interaction between the e-gifting platform 10′ and the giver terminal device 22 as well as the receiver terminal device 32 are similar to those shown in FIG. 1 and FIG. 2, and are not repeated herein.

In the e-gifting system and method provided in the disclosure, gift filtering information A2 provided by a giver and receiver information A1 are used to generate a candidate gift list L1, so as to reduce the trouble for the giver when selecting a gift. In addition, because a receiver selects a desired gift item in a gifting list, the e-gifting system and method provided in the disclosure also help improve the satisfaction of the receiver.

The above is merely exemplary embodiments of the disclosure, and does not constitute any limitation on the disclosure. Any form of equivalent replacements or modifications to the technical means and technical content disclosed in the disclosure made by a person skilled in the art without departing from the scope of the technical means of the disclosure still fall within the content of the technical means of the disclosure and the protection scope of the disclosure.

What is claimed is:

1. An e-gifting method, performed by a computer device, wherein the computer device comprises a processing unit, and the e-gifting method comprises:
receiving, by the processing unit, gift filtering information and receiver information from a giver terminal device;
generating, by the processing unit, a candidate gift list according to the gift filtering information and the receiver information, wherein the candidate gift list comprises a plurality of candidate gift items;
generating, by the processing unit, a gifting list from the candidate gift items according to giver selecting information from the giver terminal device, wherein the gifting list comprises a plurality of gifting gift items; and
confirming, by the processing unit, a selected gift item from the gifting gift items according to receiver selecting information from a receiver terminal device.

2. The e-gifting method according to claim 1, wherein the computer device is connected to a storage server, the storage server comprises inventory information, and the processing unit generates the candidate gift list according to the gift filtering information, the receiver information and the inventory information.

3. The e-gifting method according to claim 2, wherein the step of generating, by the processing unit, the gifting list from the candidate gift items according to the giver selecting information from the giver terminal device comprises locking or hiding the gifting gift items in the inventory information.

4. The e-gifting method according to claim 3, wherein the step of confirming, by the processing unit, the selected gift item from the gifting gift items according to the receiver selecting information from the receiver terminal device comprises unlocking or revealing the gifting gift items other than the selected gift item.

5. The e-gifting method according to claim 2, wherein after the step of confirming, by the processing unit, the selected gift item from the gifting gift items according to the receiver selecting information from the receiver terminal device, the method further comprises instructing, by the processing unit, the storage server to send a gift corresponding to the selected gift item to a receiver.

6. The e-gifting method according to claim 1, wherein the receiver information comprises social networking site information.

7. The e-gifting method according to claim 1, wherein the receiver information is at least one selected from a group composed of age, gender, and preference.

8. The e-gifting method according to claim 1, wherein the gift filtering information is an amount range.

9. The e-gifting method according to claim 1, further comprising: receiving, by the processing unit, a reply message corresponding to the selected gift item from the receiver terminal device, and transmitting the reply message to the giver terminal device.

10. The e-gifting method according to claim 9, wherein the reply message comprises an electronic thank-you card.

11. The e-gifting method according to claim 1, wherein after the step of confirming, by the processing unit, the selected gift item from the gifting gift items according to the receiver selecting information from the receiver terminal device, the method further comprises transmitting, by the processing unit, payment information corresponding to the selected gift item to the giver terminal device.

12. An e-gifting system, comprising:
a computer device, wherein the computer device comprises a processing unit, configured to:
receive gift filtering information and receiver information from a giver terminal device;
generate a candidate gift list according to the gift filtering information and the receiver information, wherein the candidate gift list comprises a plurality of candidate gift items;
generate a gifting list from the candidate gift items according to giver selecting information from the giver terminal device, wherein the gifting list comprises a plurality of gifting gift items;
confirm a selected gift item from the gifting gift items according to receiver selecting information from a receiver terminal device; and
transmit payment information corresponding to the selected gift item to the giver terminal device; and
a storage server, comprising inventory information,
wherein the processing unit generates the candidate gift list according to the gift filtering information, the receiver information and the inventory information.
